(19) United States
(12) Patent Application Publication
(10) Pub. No.: US 2016/0048066 A1
(43) Pub. Date: Feb. 18, 2016

(54) Method for Manufacturing Display Panel and Display Panel

(71) Applicant: SAKAI DISPLAY PRODUCTS CORPORATION, Osaka (JP)

(72) Inventor: Shinji Matsuzaki, Sakai-shi, Osaka (JP)

(21) Appl. No.: 14/784,261

(22) PCT Filed: Aug. 4, 2014
(86) PCT No.: PCT/JP2014/070514

§ 371 Date: Oct. 13, 2015

(30) Foreign Application Priority Data
Aug. 7, 2013 (JP) 2013-164442

(51) Int. Cl. G02F 1/1362

(52) U.S. Cl. CPC G02F 1/136259; G02F 2001/136263

(57) ABSTRACT

An example method for manufacturing a display panel, wherein the display panel includes: a signal wiring that transmits a signal for displaying an image and is formed on a substrate holding liquid crystal; and a voltage application wiring for applying voltage to the signal wiring, comprising: forming the signal wiring on the substrate; forming the voltage application wiring on the substrate; cutting the signal wiring; and connecting one side of the signal wiring cut by the cutting and the voltage application wiring by an ion implantation method.

### CROSS-REFERENCE TO RELATED APPLICATIONS

This application is the national phase under 35 U.S.C. §371 of PCT International Application No. PCT/JP2014/070514 which has International filing date of Aug. 4, 2014 and designated the United States of America.

### FIELD

The technology herein relates to a method for manufacturing a display panel displaying an image and a display panel.

### BACKGROUND AND SUMMARY

A thin type display apparatus, such as a liquid crystal display apparatus is, in general, widely spread because it has a display area larger than an installation area thereof. An active matrix substrate is given as an example of a display panel used in a liquid crystal display apparatus.

The active matrix substrate includes thin film transistors (hereinafter referred to as TFTs), namely switching elements formed in a matrix, a plurality of pixel electrodes formed in a matrix in correspondence to the respective TFTs, and gate wirings that are scanning wirings and source wirings that are signal wirings formed to be orthogonal to each other corresponding to the row direction and column direction of these pixel electrodes.

A gate wiring also functions as the gate electrode of TFT installed thereon, and controls driving of TFT by supplying scanning signals thereto. On the other hand, a source wiring is connected with the source electrode of each TFT and supplies data signals to pixel electrodes through TFTs when TFTs are driven. The drain electrode of TFT is connected with the pixel electrode and one terminal of an additional capacitance, and the other terminal of the additional capacitance is connected with an additional capacitance wiring, and then is connected with an opposite electrode located on an opposite substrate.

When a liquid crystal display apparatus is to be manufactured with high resolution, each pixel electrode needs to be made smaller in order to increase the number of pixel electrodes. Accordingly, each TFT also needs to be made smaller so as to increase the number of TFTs. In this case, deficiency of TFT's quality, electrical leakage between the pixel electrodes and each wiring or electrical leakage among wirings may be caused with high possibility. When the liquid crystal display apparatus is turned on, point defects or line defects can be seen, which is not favorable for the display quality thereof.

In a liquid crystal display apparatus, an opening is formed in gate wirings. One edge of the opening and the other edge opposite to the one edge, which are parallel to the gate wirings, serve as electrical paths respectively. Source wirings cross on the one and the other edges.

When a defect occurs at a crossing part where either the one or the other edge and the source wirings cross, the gate wirings are cut in the crossing part to prevent bright spots and to avoid disconnection of the gate wirings.

Electrical leakage also occurs between the source wirings and a color-filter-side substrate opposite to TFTs, or counter leakage may occur. In this case, the source wirings are cut at both sides of the part where the counter leakage occurs.

Spare wirings to apply voltage are provided around a peripheral part of the active matrix substrate. Voltage is not applied to one source wiring not connected to a drive section among the source wirings divided by cutting, and therefore, in order to prevent this, this source wiring and the spare wiring are connected and repaired by laser radiation. However, the laser radiation may not be enough to accomplish the connection.

In consideration of the above-described circumstances, an example embodiment of a method for manufacturing a display panel which may reliably make a connection for repairing when the wirings or the like on the substrate are repaired, and an example embodiment of a display panel are provided.

According to one aspect of the example embodiment, a method for manufacturing a display panel, including: a signal wiring that transmits a signal for displaying an image and is formed on a substrate holding liquid crystal; and a voltage application wiring for applying voltage to the signal wiring, comprises: forming the signal wiring on the substrate; forming the voltage application wiring on the substrate; cutting the signal wiring; and connecting one side of the signal wiring cut by the cutting and the voltage application wiring by an ion implantation method.

According to one aspect of the example embodiment, a method for manufacturing a display panel, including: a scanning wiring that transmits a scanning signal and is formed on a substrate holding liquid crystal; a signal wiring orthogonal to the scanning wiring; a switching element formed in correspondence to a position where the signal wiring and the scanning wiring cross; and an additional capacitance connected with an electrode of the switching element, comprises: forming the switching element on the substrate; forming the additional capacitance on the substrate; cutting the connection between the electrode of the switching element and the additional capacitance; and connecting both electrodes of the additional capacitance by an ion implantation method.

According to one aspect of the example embodiment, the method for manufacturing a display panel comprises disposing a mask at a side of the substrate; and irradiating the substrate with ion beams by an electron gun from a side of the mask opposite to the substrate.

According to one aspect of the example embodiment, a display panel comprises: a signal wiring that transmits a signal for displaying an image and is formed on a substrate holding liquid crystal; and a voltage application wiring for applying voltage to the signal wiring, the signal wiring is cut, one side of the signal wiring cut by the cutting is connected with the voltage application wiring, and a density of ions in a connection part between the one side of the signal wiring and the voltage application wiring is higher than that in the other part of the signal wiring.

According to one aspect of the example embodiment, a display panel comprises: a scanning wiring that transmits a scanning signal and is formed on a substrate holding liquid crystal; a signal wiring orthogonal to the scanning wiring; a switching element formed in correspondence to a position where the signal wiring and the scanning wiring cross; and an additional capacitance connected with an electrode of the switching element, the connection is cut between the electrode of the switching element and the additional capacitance, both electrodes of the additional capacitance are connected, and a density of ions at the connection part of the both electrodes is higher than a density of ions in the other part of the both electrodes.

According to one aspect of the example embodiment, the signal wiring is divided at a defect part thereof, and one side of the signal wiring cut by the dividing and the voltage application wiring are connected by the ion implantation method, so that the connection between the signal wiring and the voltage application wiring may reliably be made.

According to one aspect of the example embodiment, when electrical leakage occurs between electrodes of a switching element, the connection between the electrodes and the additional capacitance are cut, and the both electrodes of the additional capacitance are connected by ion implantation method so that the connection of the additional capacitance may reliably be made.

According to one aspect of the example embodiment, the substrate is disposed at one side (bottom side) of a mask and an electron gun irradiates the substrate with ion beam from the other side (top side) of the mask, so that a single mask may be applied to a plurality of substrates and the ion implantation method may be done more efficiently in shorter time compared to the case of irradiating the substrate with ion beam after forming a resist pattern.

In one aspect of the embodiment of the method for manufacturing a display panel and the display panel, the signal wiring is divided at a defect part thereof and one part of the signal wiring cut by the dividing and the voltage application wiring are connected by the ion implantation method, so that the connection between the signal wiring and the wiring for applying voltage may be more reliably made compared to connection by using laser. When electrical leakage occurs between the source electrode and the drain electrode of the switching element, the connection of the drain electrode and the additional capacitance is cut, and the both electrodes of the additional capacitance is connected by the ion implantation method and the connection of additional capacitance may more reliably be realized than by using laser.

### BRIEF DESCRIPTION OF THE DRAWINGS

FIG. 1 is an example of non-limiting equivalent circuit diagram of an active matrix substrate of a liquid crystal display panel according to Embodiment 1;

FIG. 2 is an example of non-limiting schematic enlarged section view illustrating a portion around a foreign body;

FIG. 3 is an example of non-limiting schematic section view illustrating a connection part;

FIG. 4A is an example of non-limiting explanatory view illustrating a way of connecting a source wiring and a spare wiring;

FIG. 4B is an example of non-limiting explanatory view illustrating a way of connecting a source wiring and a spare wiring;

FIG. 5 is an example of non-limiting schematic section view illustrating the connection part connected by laser irradiation;

FIG. 6 is an example of non-limiting equivalent circuit diagram of the active matrix substrate illustrating components around a TFT of the liquid crystal display panel according to Embodiment 2;

FIG. 7A is an example of non-limiting explanatory view illustrating a way of connecting an additional capacitance;

FIG. 7B is an example of non-limiting explanatory view illustrating a way of connecting an additional capacitance; and

FIG. 8 is an example of non-limiting schematic section view illustrating the connection part connected by laser irradiation.

### DETAILED DESCRIPTION OF NON-LIMITING EXAMPLE EMBODIMENTS

### Embodiment 1

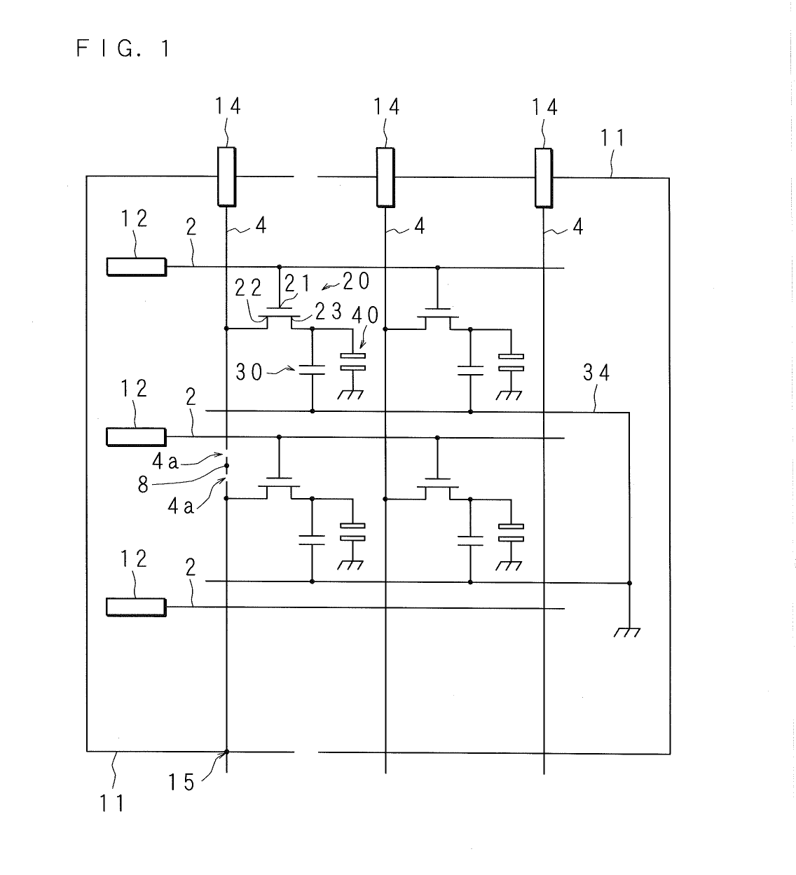

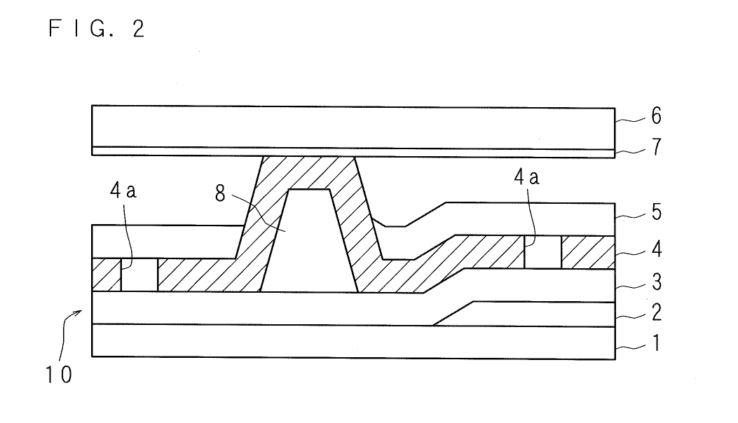

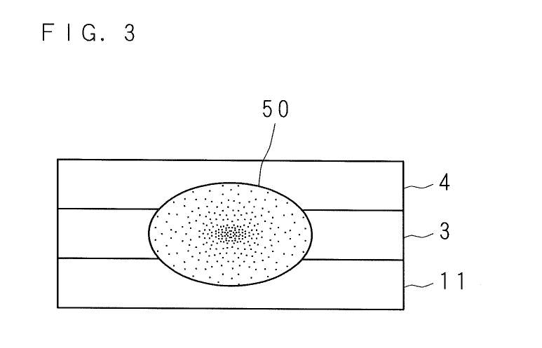

Hereinafter, the present invention is described below with reference to the drawings illustrating a liquid crystal display panel according to Embodiment 1. FIG. 1 is an equivalent circuit diagram of an active matrix substrate of a liquid crystal display panel, FIG. 2 is a schematic enlarged section view illustrating a portion around a foreign body, and FIG. 3 is a schematic section view illustrating a connection part.

A liquid crystal panel is manufactured by fabricating TFTs 20 (that is an active matrix substrate 10), interposing liquid crystal between the fabricated active matrix substrate 10 and a color-filter-side substrate, bonding both substrates, and dividing the substrates in accordance with predetermined dimensions.

The active matrix substrate 10 comprises a TFT-side glass substrate 1, gate wirings 2 provided on the TFT-side glass substrate 1, an insulation film 3 provided on the TFT-side glass substrate 1 and gate wirings 2, source wirings 4 provided on the insulation film 3, and a protection film 5 provided on the source wirings 4. The insulation film 3 is formed by plasma Chemical Vapor Deposition (CVD).

The active matrix substrate 10 faces a color-filter-side glass substrate 6. An ITO film 7 is provided on one surface of the color-filter-side glass substrate 6. The ITO film 7 and the protection film 5 of the active matrix substrate 10 face each other.

The gate wirings 2 that are scanning wirings and the source wirings 4 that are signal wirings are formed to cross in the vertical and lateral directions. For example, as shown in FIG. 1, a plurality of gate wirings 2 extending in the lateral direction are juxtaposed in the vertical direction, and a plurality of source wirings 4 extending in the vertical direction are juxtaposed in the lateral direction. The source wirings 4 are located above the gate wirings 2.

A source drive section 14 applying voltage is connected to one end of the source wiring 4. A gate drive section 12 applying voltage is connected to one end of the gate wiring 2. Spare wirings 11 are provided in a peripheral part around the active matrix substrate 10 (in other words, outside of an active area for displaying images). The spare wirings 11 are formed when the gate wirings 2 are formed, and composed of the same materials as those of the gate wirings 2. The source drive section 14 applies voltage to the spare wiring 11.

A TFT 20 is provided at the inside of a square formed by the gate wirings 2 and the source wirings 4 and located near the crossing point where the gate wiring 2 and the source wiring 4 cross. A gate electrode 21 of the TFT 20 is connected to the gate wiring 2 and a source electrode 22 thereof is connected to the source wiring 4. TFT 20 is formed on the gate wiring 2.

An additional capacitance wiring 34 is formed parallel to the gate wirings 2 between the gate wirings 2 adjacent to each other. The additional capacitance wiring 34 is grounded. An additional capacitance 30 is interposed between a drain electrode 23 of the TFT 20 and the additional capacitance wiring 34 to prevent a flicker phenomenon that screen is recognized as flickering since the liquid crystal changes its orientation at high speed. In other words, one electrode of the additional capacitance 30 is connected with the drain electrode 23 and the other electrode thereof is connected with the additional capacitance wiring 34. The drain electrode 23 is connected with one side of a pixel electrode 40. The other side of the pixel electrode 40 is grounded.

As shown in FIG. 2, on the procedure for manufacturing the active matrix substrate 10, a foreign body 8 may intrude and be positioned on the insulation film 3. The source wiring 4 is located also on the foreign body 8 when the source wiring 4 is formed. The protection film 5 is formed on the source wiring 4. Though it is difficult for the protection film 5 to cover the source wiring 4 located on the foreign body 8 since the source wiring 4 protrudes in accordance with the foreign body 8.

Therefore, the source wiring 4 touches the ITO film 7 provided on the color-filter-side glass substrate 6 and electrical leakage (counter leakage) occurs. Inspection for defects which may cause the counter leakage (such as the presence of the foreign body 8 having a predetermined height or higher) is carried out on the procedure of manufacturing the active matrix substrate 10. In this inspection, when a defect is found, both sides of the defect part in the source wiring 4 are cut (hereinafter the cut part of the source wiring 4 is also referred to as a cut section 4a). The cut section 4a may prevent the occurrence of the counter leakage.

As shown in FIG. 1, the source wiring 4 is divided into two parts, one of which is connected to the source drive section 14 and the other of which is not connected to the source drive section 14. The other part of the source wiring 4 is connected to the spare wiring 11 in order to transfer signals (voltage) from the source drive section 14.

FIG. 3 is a schematic section view illustrating a connection part 15 of the source wiring 4 and spare wiring 11. The insulation film 3 is interposed between the source wiring 4 and spare wiring 11. A layer (N+ layer) 50 containing more impurities (ions) than the other part is formed in the connection part 15. The N+ layer 50 is formed over from the insulation film 3 to the source wiring 4 and the spare wiring 11. In other words, the source wiring 4 and the spare wiring 11 are connected by the N+ layer 50.

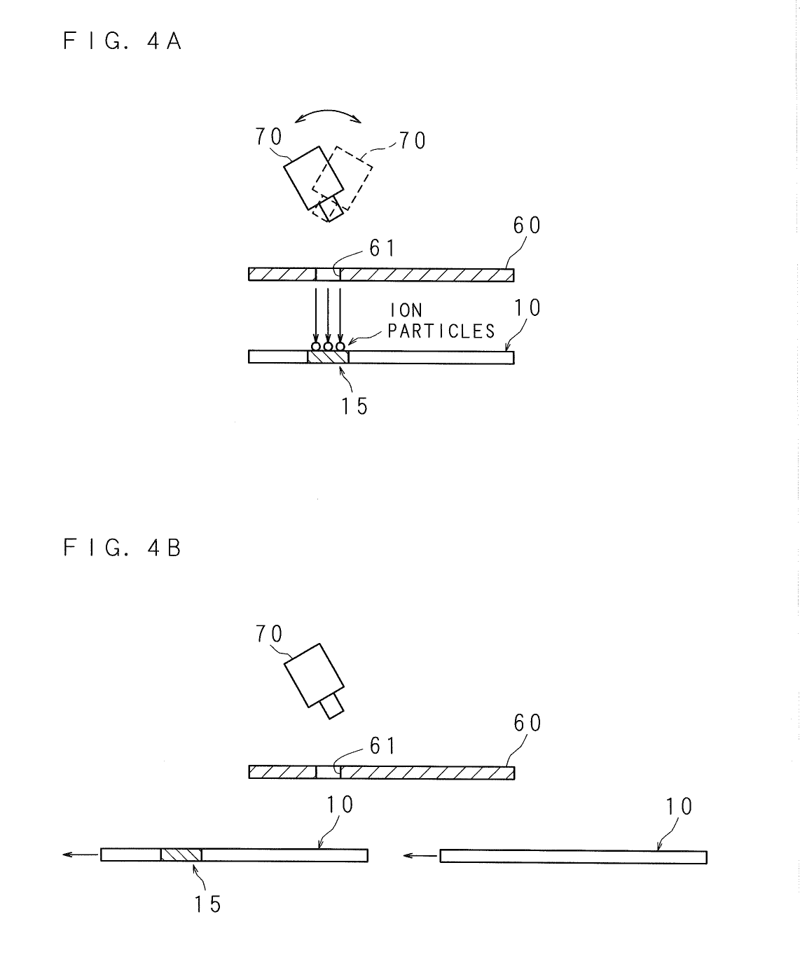

Next, a way of connecting the source wiring 4 and the spare wiring 11 is described. FIGS. 4A and 4B are explanatory views illustrating a way of connecting the source wiring 4 and the spare wiring 11.

First, a mask 60 is prepared which has a mask hole 61 at a position corresponding to the connection part 15 of the source wiring 4 and spare wiring 11. An electron gun 70 radiating ion beam is positioned above the mask hole 61. The electron gun 70 aims at the mask hole 61. The electron gun 70 is rotatable in the lateral and vertical directions. The electron gun 70 may rotate for a predetermined distance one way in the lateral direction, then may rotate for a small distance (significantly shorter than the predetermined distance) one way in the vertical direction. After that, the electron gun 70 may rotate the other way in the lateral direction for the predetermined distance, then may rotate one way in the vertical direction for a small distance and repeats these movements. As a result of such movements, a track of the ion beam radiated from the electron gun 70 may represent a zig-zag form with a series of laterally-long cranked shapes.

The active matrix substrate 10 is located at a predetermined position under the mask 60. Then, the electron gun 70 irradiates the mask hole 61 with the ion beam (ion particles) while rotating. The ion beam passed through the mask hole 61 is radiated to the connection part 15 of the source wiring 4 and the spare wiring 11, and ions are implanted into the connection part 15.

Although the irradiated area tends to be larger because the electron gun 70 radiates the ion beam while rotating, ions are implanted with a pinpoint accuracy at the connection part by using the mask 60.

For example, arsenic or phosphorus ions are given as a kind of ions used in the ion implantation. The dose of ions to be implanted is preferably 10¹⁸ [ions/cm²] or more for instant. The energy of the ion beam is preferably in the range from 500 [keV] to several [MkeV] for instance.

Here, a relation between ion density and depth of film is described. The ion density by the ion implantation method is the highest at a predetermined depth, and is lowered as the depth is deeper or shallower than the predetermined depth. Ions are implanted so as to make the ion density be the highest around the insulation film 3 in Embodiment 1.

The ion density around the source wiring 4 and the spare wiring 11 is lower than that around the insulation film 3. It is, however, enough for connecting the source wiring 4 and the spare wiring 11 electrically. The number of ion implantation may be multiplied in order to electrically connect the source wiring 4 and the spare wiring 11 when the insulation film 3 is thicker.

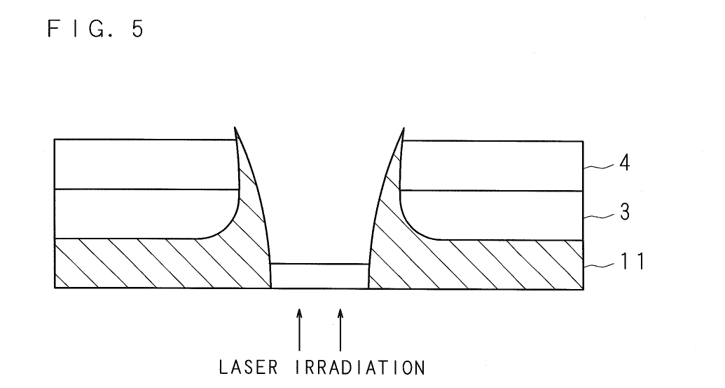

Next, the difference between the connection by the ion implantation method and the connection by the laser irradiation is described. FIG. 5 is a schematic section view illustrating the connection part 15 connected by the laser irradiation. As shown in FIG. 5, when laser is radiated at the spare wiring 11, a hole is formed in the active matrix substrate 10, and the spare wiring 11 protrudes to the source wiring 4 along the inner circumferential surface of the hole, and is connected with the source wiring 4.

The connection area by the laser irradiation is smaller than that by the N+ layer 50 since the source wiring 4 is connected with the protruding part of the spare wiring 11. Therefore, the connection may be released if, for example, distortion occurs in the display panel, or external force acts on the display panel.

As shown in FIG. 3, the whole N+ layer 50 forms the connection part and is buried inside the layers when the connection is made by the N+ layer 50. The insulation film 3 has high adhesion because of being formed by the plasma CVD so it does not easily come off even if distortion occurs in the display panel, or external force acts on the display panel. Hence, more reliable connection may be realized.

In the method for manufacturing a display panel and the display panel according to Embodiment 1, the source wiring 4 is divided at the defect part thereof. The source wiring 4 disconnected from source drive section 14 is connected to the spare wiring 11 by the ion implantation method, so that the connection between the source wiring 4 and the spare wiring 11 may be more reliably made than the connection by using laser.

The active matrix substrate 10 is disposed at the bottom side of the mask 60 and the electron gun 70 irradiates the substrate 10 with ion beam from the top side of the mask 60, so that the single mask 60 may be applied to a plurality of active matrix substrates 10 or may be utilized for the single active matrix substrate 10 multiple times. Hence, the ion implantation method may be performed more efficiently in shorter time than the case of irradiating with ion beam after forming a resist pattern, which can reduce the cost for manufacturing.

### Embodiment 2

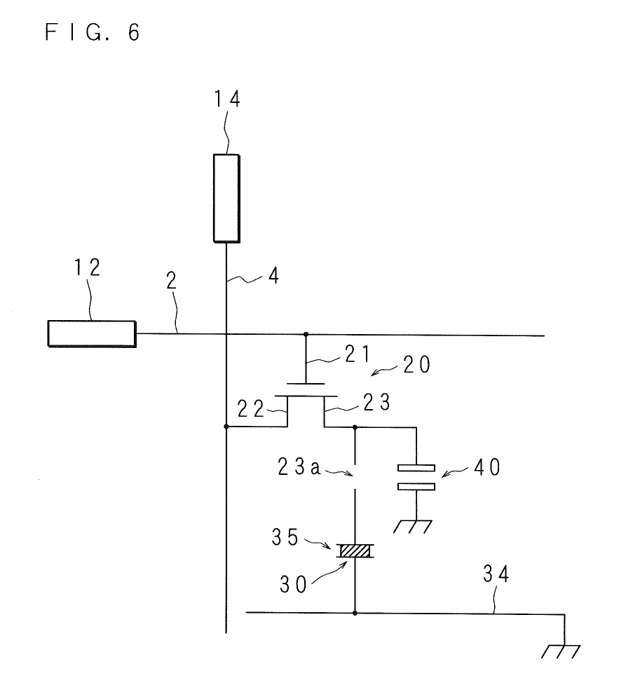

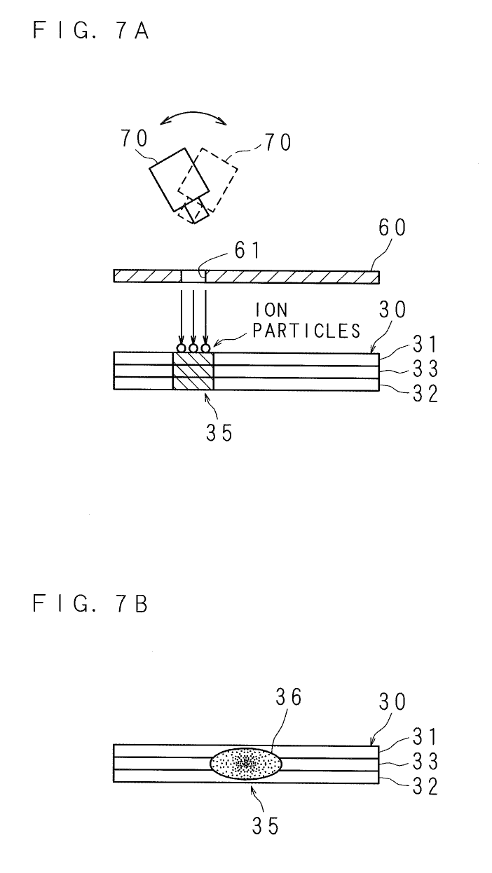

Hereinafter, the present invention is described below with reference to the drawings illustrating a liquid crystal display panel according to Embodiment 2. FIG. 6 is an equivalent circuit diagram of the active matrix substrate 10 illustrating components around a TFT 20, and FIGS. 7A and 7B are explanatory views illustrating a way of connecting an additional capacitance 30. Short circuit, i.e. S-D leakage, may occur between the drain electrode 23 and the source electrode 22 of the TFT 20 on the procedure of manufacturing the active matrix substrate 10. In this case, the pixel with S-D leakage becomes a bright spot in a normally black panel.

Hence, an inspection is carried out on the active matrix substrate 10 during the procedure of manufacturing the active matrix substrate 10, and when the S-D leakage is found, a wiring is cut which connects the drain electrode 23 and the additional capacitance 30 of the TFT 20 as shown in FIG. 6 (hereinafter the part cut is also referred to as a cut section 23a). The both electrodes of the additional capacitance 30 are connected in order for the additional capacitance 30 to have the same potential (0V) as that of the additional capacitance wiring 34. The cut section 23a prevents the potential of the drain electrode 23 from being affected by the potential of the additional capacitance 30.

As shown in FIG. 7, the additional capacitance 30 is configured by interposing an insulation film 33 which is a dielectric between a first metal layer 31 and a second metal layer 32 which are electrodes. Each of the first and second metal layers 31, 32 are formed when the source wirings 4 and gate wirings 2 are formed, and configured by the same constituents as those of the source wirings 4 and the gate wirings 2.

As shown in FIG. 7B, an N+ layer 36 is formed at a connection part 35 of the additional capacitance 30. The N+ layer 36 is formed over from the insulation film 33 to the first and second metal layers 31, 32. In other words, the first and second metal layers 31, 32 are connected by the N+ layer 36.

Next, a way of connecting the first and second metal layers 31, 32 are described.

As shown in FIG. 7A, firstly the mask 60 with a mask hole 61 is prepared at a position corresponding to the connection point 35 of the first and the second metal layers 31 and 32. The electron gun 70 radiating ion beam is positioned above the mask hole 61. The electron gun 70 aims at the mask hole 61. The electron gun 70 is rotatable in the lateral and vertical directions. The electron gun 70 may rotate predetermined distance one way in the lateral direction, then may rotate for a small distance (significantly shorter than the predetermined distance) one way in the vertical direction. After that, the electron gun 70 may rotate the other way in the lateral direction for the predetermined distance, then may rotate one way in the vertical direction for a small distance and repeats these movements. As a result of such movements, a track of the ion beam radiated from the electron gun 70 may represent a zig-zag form with a series of laterally-long cranked shapes.

The active matrix substrate 10 is located predetermined position under the mask 60. Then, the electron gun 70 irradiates the mask hole 61 with the ion beam while rotating. The ion beam passed through the mask 61 is radiated to the connection part 35 of the first and second metal layers 31 and 32, and ions are implanted into the connection part 35.

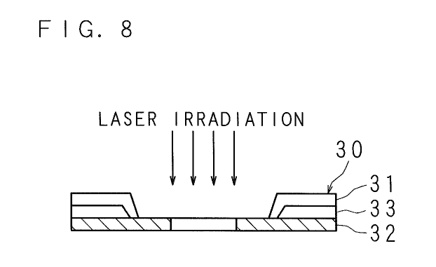

FIG. 8 is a schematic section view illustrating the connection part 35 connected by laser irradiation. A hole is formed in the active matrix substrate 10, and the first metal layer 31 protrudes to the second metal layer 32 along the inner circumferential surface of the hole, and is connected with the second metal layer 32 when the connecting of both electrodes of the additional capacitance 30 is carried out by laser irradiation. The connection area by the laser irradiation is smaller than that by the N+ layer 36 since the second metal layer 32 is connected with the protruding part of the first metal layer 31.

As shown in FIG. 7B, when the connection is made by the N+ layer 36, the connection may be realized more reliably since the whole N+ layer 36 forms the connection part and is buried inside layers.

With the method for manufacturing a display panel and the display panel according to Embodiment 2, when electrical leakage occurs between the source electrode 22 and the drain electrode 23 of the TFT 20, the connection of the drain electrode 23 and the additional capacitance 30 is cut, the both electrodes of the additional capacitance 30 is connected by the ion implantation method, so that more reliable connection of additional capacitance 30 may be carried out than the case by using laser.

Same reference numerals are assigned to the components of the display panel in the Embodiment 2 which are similar to those in Embodiment 1, and detailed description thereof is not repeated.

The embodiments as disclosed are illustrative and not restrictive in all respects. The technical features described in the respective embodiments can be combined with each other, and the scope of the present invention is defined by the claims rather than by the description preceding them, and all changes that fall within metes and bounds of the claims, or equivalence of such metes and bounds thereof are therefore intended to be embraced by the claims.

1-5. (canceled)

6. A method for manufacturing a display panel,
wherein the display panel includes:
a signal wiring that transmits a signal for displaying an image and is formed on a substrate holding liquid crystal; and
a voltage application wiring for applying voltage to the signal wiring,
comprising:
forming the signal wiring on the substrate;
forming the voltage application wiring on the substrate;
cutting the signal wiring; and
connecting one side of the signal wiring cut by the cutting and the voltage application wiring by an ion implantation method.

7. A method for manufacturing a display panel,
wherein the display panel includes:
a scanning wiring that transmits a scanning signal and is formed on a substrate holding liquid crystal;
a signal wiring orthogonal to the scanning wiring;
a switching element formed in correspondence to a position where the signal wiring and the scanning wiring cross; and
an additional capacitance connected with an electrode of the switching element,
the method comprises:
forming the switching element on the substrate,
forming the additional capacitance on the substrate,
cutting the connection between the electrode of the switching element and the additional capacitance, and
connecting both electrodes of the additional capacitance by an ion implantation method.

8. The method for manufacturing a display panel according to claim 6, further comprising:
disposing a mask at a side of the substrate; and
irradiating the substrate with ion beams by an electron gun from a side of the mask opposite to the substrate.

9. The method for manufacturing a display panel according to claim 7, further comprising:
disposing a mask at a side of the substrate; and
irradiating the substrate with ion beams by an electron gun from a side of the mask opposite to the substrate.

10. A display panel, comprising:
a signal wiring that transmits a signal for displaying an image and is formed on a substrate holding liquid crystal; and
a voltage application wiring for applying voltage to the signal wiring,
wherein
the signal wiring is cut,
one side of the signal wiring cut by the cutting is connected with the voltage application wiring, and
a density of ions in a connection part between the one side of the signal wiring and the voltage application wiring is higher than a density of ion in other part of the signal wiring.

11. A display panel, comprising:
a scanning wiring that transmits a scanning signal and is formed on a substrate holding liquid crystal;
a signal wiring orthogonal to the scanning wiring;
a switching element formed in correspondence to a position where the signal wiring and the scanning wiring cross; and
an additional capacitance connected with an electrode of the switching element,
wherein
the connection is cut between the electrode of the switching element and the additional capacitance,
both electrodes of the additional capacitance are connected, and
a density of ions at the connection part of the both electrodes is higher than a density of ions in the other part of the both electrodes.
